(19) United States
(12) Patent Application Publication
(10) Pub. No.: US 2007/0115136 A1
(43) Pub. Date: May 24, 2007

(54) Contact signal transmission and reception apparatus

(76) Inventors: Yuichi Abe, Mito (JP); Kimiaki Taniguchi, Nakai (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/600,038

(22) Filed: Nov. 16, 2006

(30) Foreign Application Priority Data
Nov. 18, 2005 (JP) 2005-334110

(51) Int. Cl. G06F 13/42

(52) U.S. Cl. 340/825; 398/135

(57) ABSTRACT

Contact control I/F (interface) to attain transmission and reception of a contact signal with various contact specifications, which is electrically insulated from a circuit inside an apparatus by an insulation element. A plurality of signal terminals which carry out transmission and reception of a contact signal, and a switching unit for selectively setting at least one of the plurality of signal terminals at any one of an input terminal or an output terminal, are installed at a control apparatus for carrying out transmission and reception of a contact signal which is electrically isolated.

### BACKGROUND OF THE INVENTION

The present invention relates to I/F (interface) technology for controlling contacts or contact points, which are electrically insulated or isolated.

A contact signal is known as a signal transmitted between a transmission side apparatus and a reception side apparatus. Transmission of this contact signal is carried out by, for example, installing an power source (power supply) and a switch at the transmission side apparatus, placing an electric bulb or light bulb at the reception side apparatus, connecting the transmission side apparatus and the reception side apparatus by two cable lines, and turning on and off the electric bulb at the reception side apparatus by open/close of the switch at the transmission side apparatus. A switch used for transmission of a contact signal may be any one as long as it is capable of electrically open and close a circuit, and a mechanical type relay or a transistor and the like are used. In addition, in the above-described example, an electric bulb is explained as one capable of detecting open/close of a circuit, however, an LED (Light Emitting Diode) and the like are often used.

As conventional technology for transmission and reception of a contact signal, in a system of installing power source at a reception apparatus side, the technology to switch a direction of electric current between a transmission side apparatus and reception side apparatus has been known (for example, JP-A-7-36368). In JP-A-7-36368, switching of a direction of electric current is attained by installment of a switching part of reception power source direction and a bi-directional electric current detection part corresponding to a direction of bi-directional electric current.

### SUMMARY OF THE INVENTION

In the meanwhile, there are various kinds of control specifications for object apparatus/units which are to be controlled by a contact signal (hereinafter referred to as “contact control specification”). Therefore, a control apparatus for controlling plural kinds of controlled object apparatus/units is desirably arranged such that it is capable of responding to controlled object apparatus/units having different kinds of contact control specifications. For example, because there is a case where the contents of an input terminal and an output terminal are different depending on contact control specifications, such a configuration is required that is capable of responding to contact control specifications different in contents of an input terminal and an output terminal.

In addition, in the case of carrying out highly reliable control by a contact signal, a circuit of the contact signal is required to be one endurable to a certain degree of high voltage. Therefore, the voltage of a circuit for carrying out transmission and reception of a contact signal is set higher than the voltage applied to a microcomputer for control and the like. Therefore, the contact signal is required to be insulated from an internal circuit by a photocoupler and the like, to protect inner components of the microcomputer and the like.

Technology described in JP-A-7-36368 considers insulation between a contact signal and an internal circuit, and a switching of a direction of electric current in the case where power source is installed at a reception side, however, does not consider a method for responding to control specifications with different contents of an input terminal and an output terminal. In addition, as a method for switching between input and output (I/O) of one terminal, there is a method for switching input (DI) and output (DO) by an I/O pin of a microcomputer and the like, however, this method is not capable of transmitting and receiving a contact signal under a different voltage from that of the microcomputer, because a contact signal is not insulated.

The present invention has been made in consideration of the above situation, and an object of the present invention is to provide a contact control interface (I/F), which is electrically insulated from a circuit inside the apparatus by an insulating element and attains transmission and reception of signals with various contact control specifications.

To solve the above-described problem, one embodiment of the present invention is applied to a contact signal transmission and reception apparatus having a transmission and reception part for carrying out transmission and reception of a contact signal which is electrically insulated.

And, the contact signal transmission and reception apparatus is installed with a plurality of signal terminals for carrying out transmission and reception of said contact signal, and the transmission and reception part has an I/O switching means for setting at least one of the plurality of signal terminals as either an input terminal for inputting the contact signal or an output terminal for outputting said contact signal, selectively.

According to the embodiments of the present invention, a transmission and reception apparatus for carrying out transmission and reception of a contact signal which is electrically insulated has the means for setting at least one of the plurality of signal terminals to be an arbitrary one of an input terminal and an output terminal, selectively. Therefore, according to the embodiments, an interface (I/F) for contact control is provided to attain transmission and reception of signals corresponding to various contact control specifications in a transmission and reception apparatus for carrying out transmission and reception of a contact signal which is electrically insulated.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic diagram useful for explaining a control system utilizing a control apparatus according to one embodiment of the present invention.

FIG. 2 is a view showing a control apparatus 100 of the embodiment of the present invention and a cable 150 connecting to the control apparatus 100.

FIG. 3 is a block diagram of a printed circuit board which the control apparatus 100 of the embodiment of the present invention has.

FIG. 4 is a table showing an example of a control specification for power source control object apparatus/unit of an embodiment of the present invention.

FIG. 5 is a diagram useful for explaining a relationship between ISOIN 1110 or ISOOUT 1120 of the control apparatus 100 of the embodiment of the present invention and a microcomputer 1100.

FIG. 6 shows ISOIN 1110 or ISOOUT 1120 connecting to each terminal of a contact signal of ports which the control apparatus 100 of the embodiment of the present invention has, and a circuit diagram of the control apparatus excluding the I/O pins of the microcomputer 1100.

FIG. 7 is a schematic diagram showing a circuit configuration for setting an I/O switching part 2200 of the control apparatus 100 of an embodiment from the I/O pin of the microcomputer 1100.

FIG. 8 is a schematic diagram of a circuit configuration wherein a photocoupler having usual polarity is used to realize the same function of a reverse-parallel connected photocoupler included in a bi-directional electric current detecting part 2300 of the embodiment of the present invention.

FIG. 9 is a schematic diagram of a circuit configuration wherein a photocoupler having usual polarity is used to realize a photo-relay of the bi-directional circuit open/close part 2400 of the embodiment of the present invention.

FIG. 10 is a schematic diagram useful for explaining transmission and reception of a setting signal carried out between a transmission side apparatus and a reception side apparatus.

FIG. 11 is schematic diagrams useful for explaining transmission and reception of a contact signal.

FIG. 12 is a diagram useful for explaining an example of a conversion connector according to an embodiment of the present invention.

### DESCRIPTION OF THE EMBODIMENTS

A control apparatus wherein one embodiment of the present invention is applied is explained below using drawings.

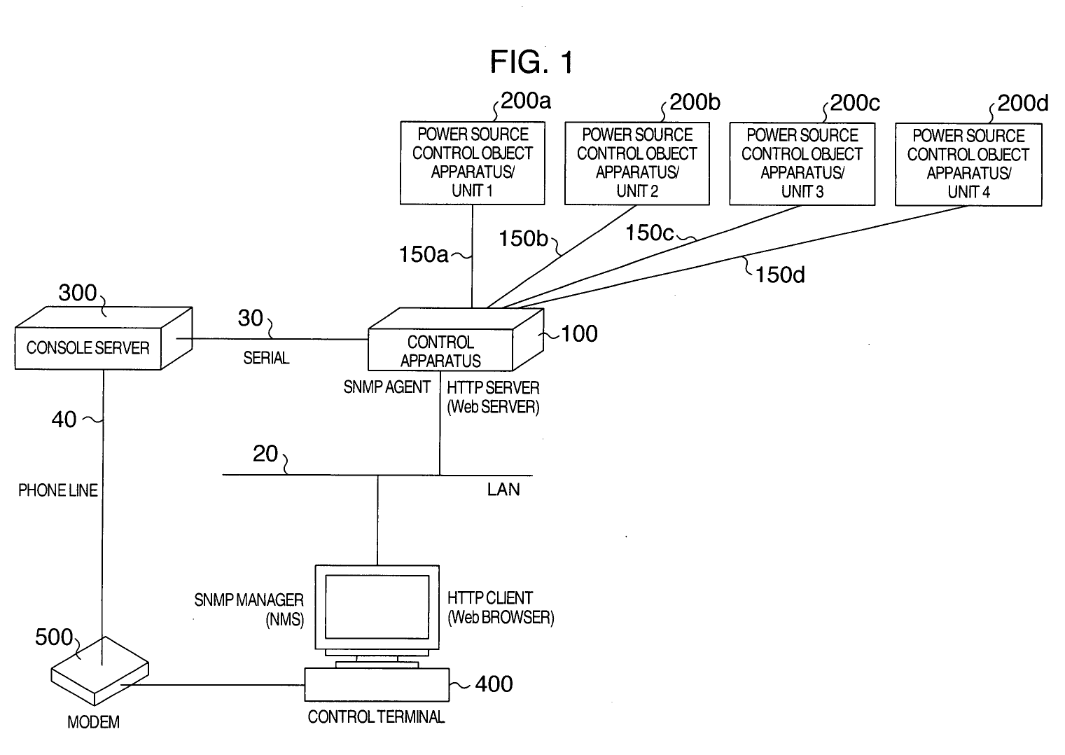

FIG. 1 explains general framework of a control system, wherein one embodiment of the present invention is utilized.

As shown in the Figure, the control system has a control apparatus 100, power-source controlled object apparatus/units 200a to 200d whose power supplies are controlled by the control apparatus 100, a console server 300, a control terminal 400, and a modem 500. The control apparatus 100 is connected to the power-source control object apparatus/units 200a to 200d by cables 150a to 150d. In addition, the control apparatus 100 and the control terminal 400 are each connected to a LAN (Local Area Network) 20. The control terminal 400 is also connected to the modem 500 separately from the LAN 20. The modem 500 is connected to the console server 300 via a phone line 40. Furthermore, the control apparatus 100 and the console server 300 are connected by a serial (for example, RS-232C) 30. In addition, in the explanation of the present embodiment, the case where four power source control object apparatus/units 200a to 200d are connected is explained, however, this is only for illustrative purpose. At least one power source control object apparatus/unit 200 may be sufficient.

The control terminal 400 receives instructions from users via an input apparatus, not shown, and executes various instructions (for example, control instructions to the power source control object apparatus/unit 200) to the control apparatus 100 via the LAN 20 or the serial (for example, RS-232C) 30.

Specifically, the control apparatus 100 is designed to have a function as an HTTP (HyperText Transfer Protocol) server and also have a function as a SNMP (Simple Network Management Protocol) agent. And, the control apparatus 100 communicates with the control terminal 400 having a function as an HTTP client via the LAN 20, by the function as an HTTP server, and receives instructions from users. In addition, the control apparatus 100 communicates with the control terminal 400 as an NMS (Network Management System) having a function as an SNMP manager, via the LAN 20, by a function as an SNMP agent, and receives instructions from users.

In addition, in the present embodiment, the control terminal 400 is also capable of accessing to the control apparatus 100 through the serial 30, via the phone line 40 and the console server 300. Namely, the control terminal 400 is capable of issuing various instructions to the control apparatus 100 via the phone line 40.

Then, the control apparatus 100 receives instructions from the control terminal 400 to carry out ON/OFF control and the like of power source utilizing a contact signal, for the four apparatus/units (power source control object apparatus/units 200a to 200d), individually or in a cooperating manner.

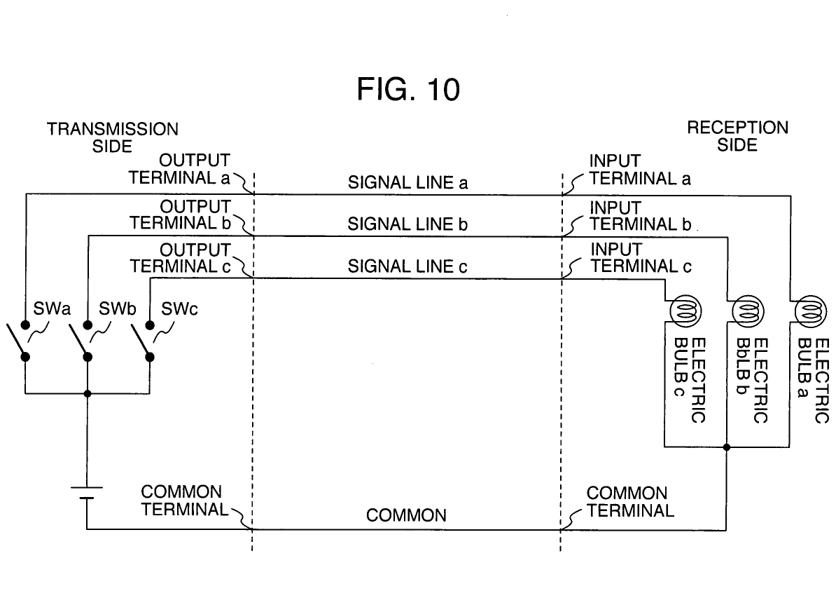

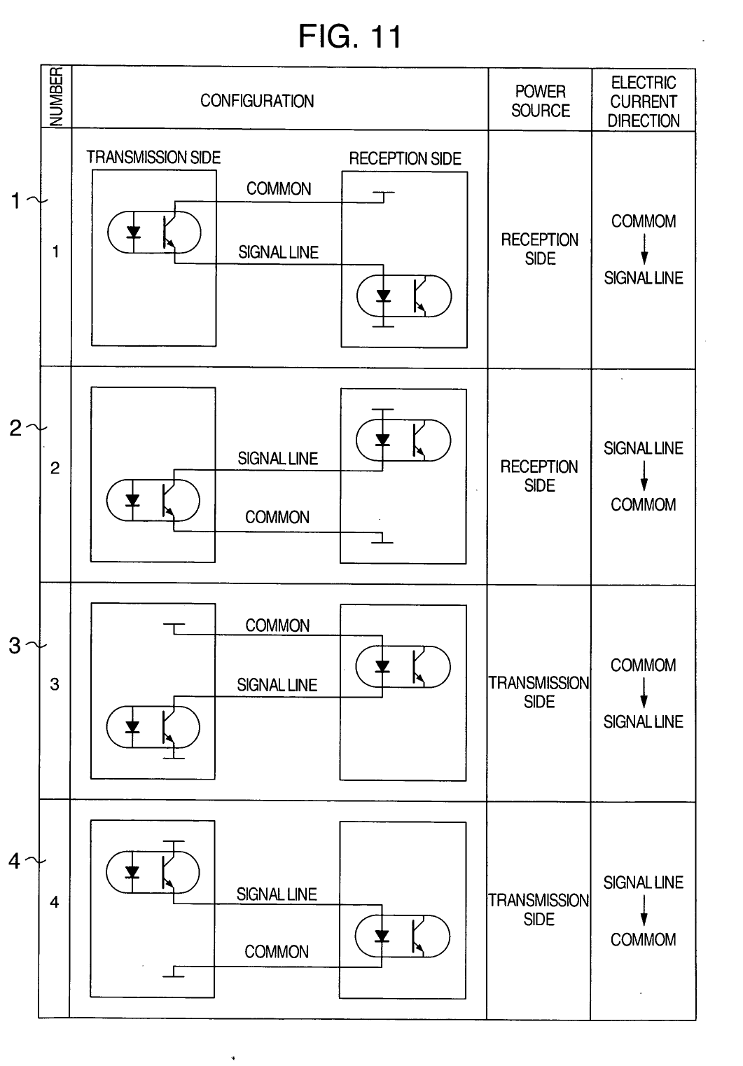

Here, explanation is given of a contact signal which the control apparatus 100 of the present embodiment uses, using FIGS. 10 and 11. FIG. 10 explains transmission and reception of a setting signal which is made between a transmission side apparatus and a reception side apparatus.

As shown in the Figure, a power source and three switches SWa to SWc are installed at the transmission side, while at the reception side are provided an electric bulb “a” turning on and off by open/close of the switch SWa, an electric bulb “b” turning on and off by open/close of the switch SWb, and an electric bulb “c” turning on and off by open/close of the switch SWc.

In the meanwhile, transmission and reception of a contact signal requires at least two lines for electric current to be able to flow into and return from a circuit. And, in the case where contact signals are to be transmitted and received by a plurality of circuits, one of two lines that are required in each circuit can be commonly used. In an example shown in the Figure, a route for returning from a reception side to a transmission side is used as one “common” line. This line is referred to as a “common” line, and the lines other than the common line are referred to as “signal line(s)”. In addition, a terminal connecting the “common” line at a transmission side and a reception side is referred to as a “common terminal(s)”.

In an example shown by the Figure, a rout going from a transmission side to a reception side is connected by three signal lines “a” to “c”. Specifically, the switch SWa at a transmission side and the electric bulb “a” at a reception side are connected via the signal line “a”; the switch SWb at a transmission side and the electric bulb “b” at a reception side are connected via the signal line “b”; and the switch SWc at a transmission side and the electric bulb “c” at a reception side are connected via the signal line “c”. In addition, a terminal connecting a signal line at a reception side is referred to as an input terminal, while a terminal connecting a signal line at a transmission side is referred to as an output terminal.

Then, for example, by closing the switch SWa at a transmission side, electric current flows to the electric bulb “a” at a reception side through the signal line “a” via the output terminal “a”, and the electric current returns to a transmission side via the “common” line. In addition, for example, by closing the switch SWb at a transmission side, electric current flows to the electric bulb “b” at a reception side through the signal line “b” via the output terminal “b”, and the electric current returns to a transmission side via the “common” line. At a reception side, various instructions are received by turning on or off the electric bulb in response to open/close of the switches SWa to SWc.

Next, a contact signal transmission and reception system is explained using FIG. 11 in the cases where the power source is installed at a transmission side apparatus and where the power source is installed at a reception side apparatus.

FIG. 11 shows four types of contact signal transmission and reception systems classified based on whether the power source is provided on a reception side apparatus or on a transmission side apparatus and also on a flow direction of electric current.

A contact signal transmission and reception system 1 denoted as “No. 1” shown in the Figure is a system wherein electric current flows from “common” to a signal line, by installment of a power source at a reception apparatus side. A contact signal transmission and reception system 2 denoted as “No. 2” is a system wherein electric current flows from a signal line to “common”, by installment of a power source at a reception apparatus side. A contact signal transmission and reception system 3 denoted as “No. 3” is a system wherein electric current flows from “common” to a signal line, by installment of a power source at a transmission apparatus side. A contact signal transmission and reception system 4 denoted as “No. 4” is a system wherein electric current flows from a signal line to “common”, by installment of a power source at a transmission apparatus side.

An example shown in the Figure uses a photocoupler instead of a switch and an electric bulb explained in connection with the above-described FIG. 10. A photocoupler is a device which is a combination of an LED and a phototransistor, wherein the LED emits light when electric current flows into the forward direction of the LED and electric current flows into the forward direction of the phototransistor. In addition, according to the four systems shown, arrangement directions of the LED, phototransistor and power source relative to the “common” and the signal line are determined. In this way, by once converting an electric signal to light like this, an LED side and a phototransistor side are electrically insulated or isolated. As a result, protection of control devices (for example, microcomputer) inside a transmission side apparatus and a reception side apparatus is secured.

In the meanwhile, in the case where communication is to be made by a contact signal between two apparatus (for example, apparatus A and apparatus B), it is hardly the case that a signal is unilaterally transmitted from the apparatus A to apparatus B, or from the apparatus B to the apparatus A. In general, a signal is transmitted and received bi-directionally from the apparatus A to the apparatus B, and from the apparatus B to the apparatus A. In this case, the apparatus A and the apparatus B are both a transmission side and both a reception side. Consequently, the apparatus A and the apparatus B have a plurality of I/O terminals.

In addition, a system of transmission and reception from the apparatus A to apparatus B, and a system of transmission and reception from the apparatus B to apparatus A are not necessarily the same. For example, in transmission and reception of a contact signal from the apparatus A to apparatus B, illustrated “No. 1” system of transmission and reception may be adopted, while illustrated “No. 3” system of transmission and reception may be adopted in transmission and reception of a contact signal from the apparatus B to the apparatus A. In this case, it is enough that power source is installed only at the apparatus B, which contributes to compact sizing of the apparatus A.

Because transmission and reception of a contact signal can be classified into four transmission and reception systems as described above, it is desirable that a control apparatus is arranged so as to be able to respond to the four transmission and reception systems. The control apparatus 100 of the present embodiment, as described later, is composed so as to respond to the four transmission and reception systems. In addition, the control apparatus 100 of the present embodiment is so designed that a terminal for transmission and reception of a contact signal can selectively be set as either for input or for output. Therefore, in the present embodiment, the control apparatus 100 is capable of responding to various contact control specifications.

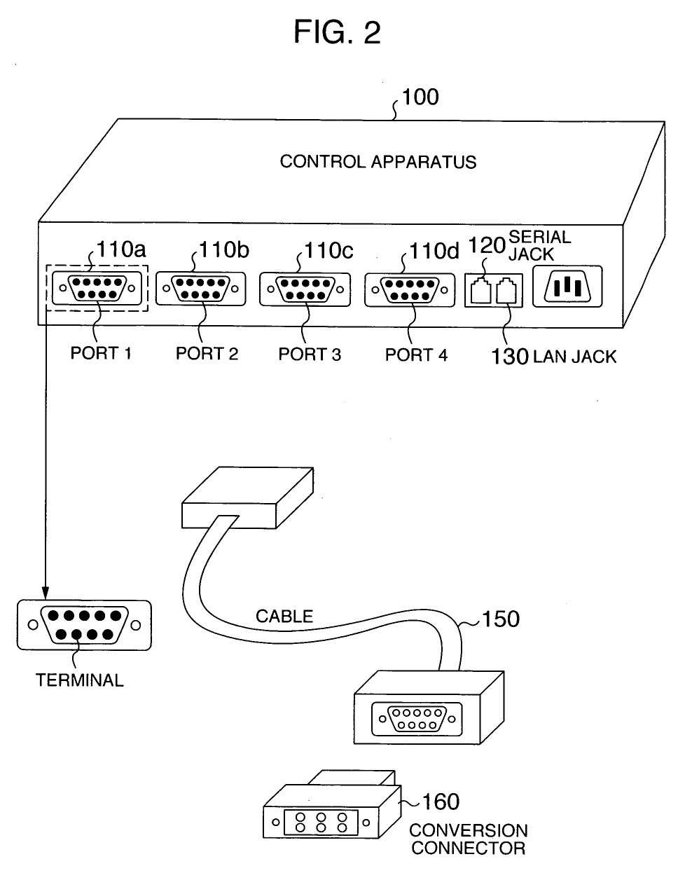

Now, an external appearance of the control apparatus 100 of the present embodiment and port configuration for transmission and reception of a contact signal will be explained. FIG. 2 illustrates external appearances of the control apparatus 100 of the embodiment of the present invention and the cable 150 for connecting to the control apparatus 100.

As shown in the Figure, the control apparatus 100 has ports 110a to 110d for connecting a cable 150 for transmission and reception of a contact signal among the power source control apparatus/units 200a to 200d. In addition, the control apparatus 100 has a serial jack 120 for connecting with the serial 30 and a LAN jack 130 for connecting with the LAN 20.

As the ports 110a to 110d and the cable 150, for example, standard products (serial cross cable and the like of standard D-SUB 9 pins) relatively easily available and in low price such as D-SUB 9 pins and the like may be used. In the example shown in Figure, the ports 110a to 110d are installed with nine terminals (input terminal, output terminal and “common” terminal).

In addition, the cable 150 in its original form may have a different shape from those of the connectors at the power source control apparatus/units 200a to 200d side. In such a case, as shown in the Figure, a conversion connector 160 fitting to the shapes of the connectors of the power source control apparatus/units 200a to 200d is utilized.

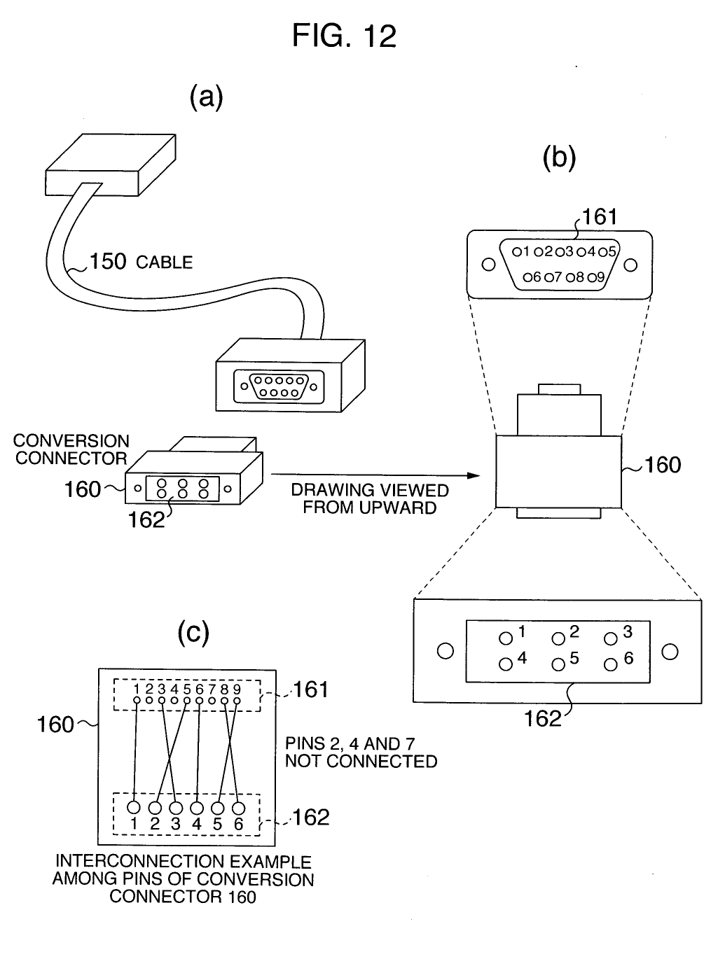

Here, examples of the conversion connector 160 are shown in FIG. 12. FIG. 12 shows one example of the conversion connectors. In FIG. 12, (a) shows an external appearance of the conversion connector 160; (b) an external appearance of the connector shape of the conversion connector 160; and (c) a connection relationship among pins of the conversion connector 160.

As is shown in the Figure, the conversion connector 160 is provided with a connector part 161 having nine terminals (9 pins) and a connector part 162 having six terminals (6 pins). The conversion connector 160 carries out pin number conversion from “9 pins” to “6 pins”, and conversion of connector shape. In this case, connection among connector pins of the conversion connector 160 is carried out as shown, for example, in FIG. 12(C). In FIG. 12(C), the “terminal 1” of the “9 pins” side is connected to the “terminal 1” of the “6 pins” side; the “terminal 3” of the “9 pins” side is connected to the “terminal 3” of the “6 pins” side; the “terminal 5” of the “9 pins” side is connected to the “terminal 2” of the “6 pins” side; the “terminal 6” of the “9 pins” side is connected to the “terminal 4” of the “6 pins” side; the “terminal 8” of the “9 pins” side is connected to the “terminal 6” of the “6 pins” side; and the “terminal 9” of the “9 pins” side is connected to the “terminal 5” of the “6 pins” side. In addition, the “terminal 2”, the “terminal 4”, and the “terminal 7” of the “9 pins” side of the conversion connector 160 are not connected to the terminal of the “6 pins” side. And, not only the connector shape but also pin arrangement (each pin is assigned to which pin) can be converted by the conversion connector 160.

Note that while the above-described explanation was made on the conversion case of the pin number and the connector shape by the conversion connector 160, the conversion of the pin number and the connector shape may be carried out by the connection-cable 150. Furthermore, in this case, the connection-cable 150 may carry out also conversion of the pin arrangement (each pin is assigned to which pin).

Here, the pin arrangement may be changed by software executed by a microcomputer inside the control apparatus 100. However, software of microcomputer is not capable of changing the assignment of a common terminal because the assignment of a common terminal requires physical connection change. Therefore, as described above, assignment of a common terminal can be made by utilizing the conversion connector 160 (or the conversion-cable 150).

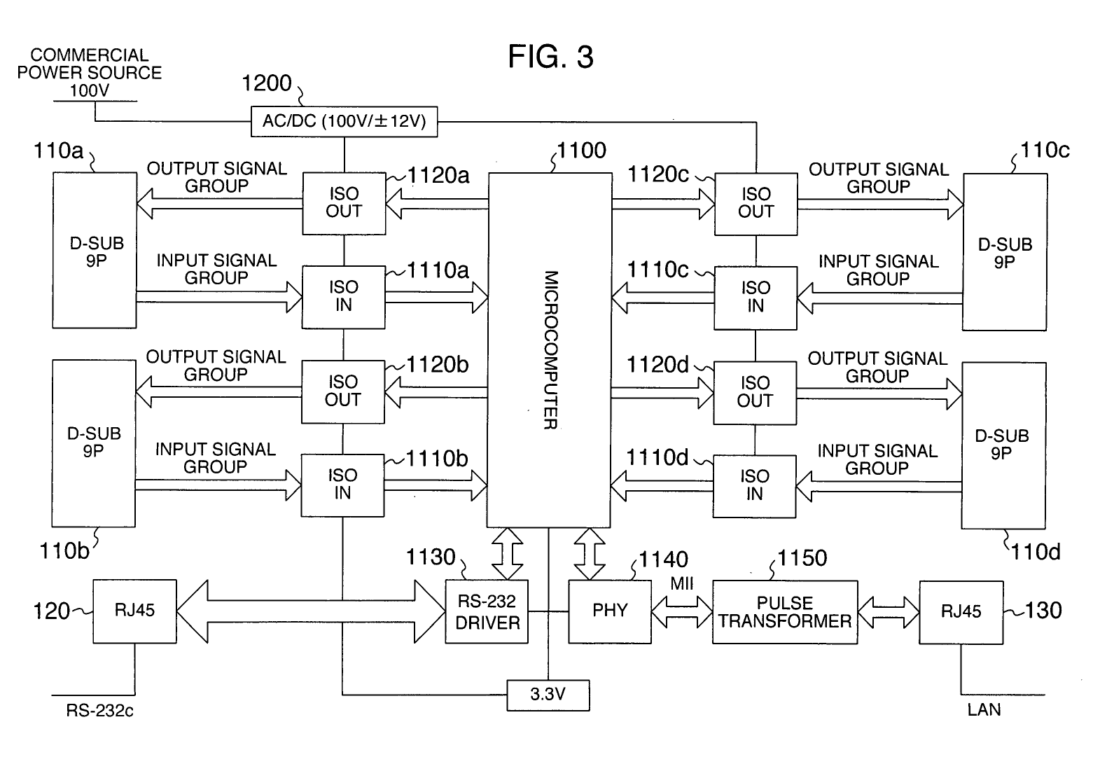

Now, configuration of a printed circuit board in the control apparatus 100 of the present embodiment is explained. FIG. 3 is a block diagram of a printed circuit board which the control apparatus 100 of the present embodiment has.

As shown in the Figure, the printed circuit board has a voltage converter 1200 for converting commercial 100 Volt power supply to “±12 V”, a microcomputer 1100 for carrying out various processing, ISOINs 1110a to 1110d, ISOOUTs 1120a to 1120d, ports 110a to 110d, a RS-232C driver 1130, an I/O terminal 120 for serial, a PHY (physical layer) 1140, a pulse transformer 1150 and an I/O terminal 130 for LAN.

The microcomputer 1100 carries out control processing for the power source control apparatus/units 200a to 200d via the cable 150 (see FIG. 1). The power source converter 1200 converts commercial 100 Volt power source to “±12 V”, and supplies thus converted voltage to the ISOINs 1110a to 1110d and ISOOUTs 1120ato 1120d, as power source for transmission and reception processing of a contact signal. The ISOINs 1110a to 1110d and ISOOUTs 1120a to 1120d are photocouplers for input and output, respectively, and devices including peripheral circuits thereof and carry out the transmission and reception processing of a contact signal. And, the ISOINs 1110a to 1110d and ISOOUTs 1120a to 1120d are connected to terminals of input signal groups and output signal groups of contact signals of each of the ports 110a to 110d. In the present embodiment, a transmission and reception system for inputting and outputting is changed for each port by a method to be described later.

Furthermore, the microcomputer 1100 controls the RS0232 driver 1130, and executes communication processing via the serial I/O signal terminal 120. In addition, the microcomputer 1100 controls the PHY1140 and the pulse transformer 1150 to execute communication processing via the LAN I/O terminal 130.

Note that the above-described processing executed by the microcomputer 1100 is attained by running a program stored in a memory, not shown, by the microcomputer 1100.

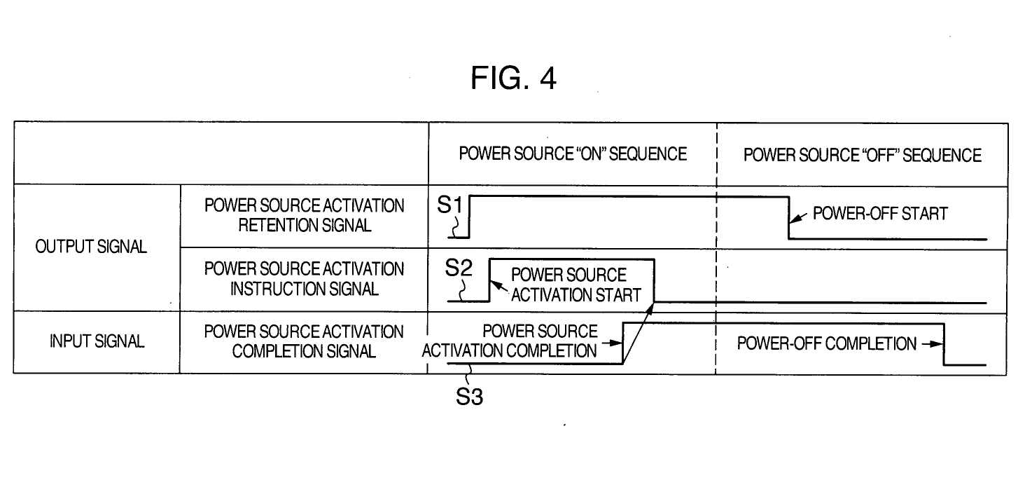

Subsequently, a control specification by a contact signal carried out by the control apparatus 100 of the present embodiment for the power source control object apparatus/unit 200, is explained using FIG. 4. FIG. 4 shows one example of a control specification for power source control object apparatus/unit of the present embodiment.

In the example shown in the Figure, the control apparatus 100 is shown to have a power source activation retention signal S1 and a power source activation instruction signal S2 as output signals of the control apparatus 100 and a power source activation completion signal S3 as an input signal of the control apparatus.

When the power source of the power source control object apparatus/unit 200 is controlled to be set “ON”, the control apparatus 100 sets output of the power source activation instruction signal S2 at “ON” while keeping the output of the power source activation retention signal S1 in “ON” state. The power source activation is started on the power source control object apparatus/unit 200 side in the case where the power source activation retention signal S1 is “ON” and the power source activation instruction signal S2 is “ON”. The power source control object apparatus/unit 200 sets the power source activation completion signal S3 at “ON” when the power source activation is started.

The control apparatus 100 sets the output of the power source activation instruction signal S2 at “OFF” in the case where the power source activation completion signal S3, which is an input signal from the power source control object apparatus/unit 200, is “ON” (namely, in the case where the power source activation completion signal S3, which the power source control object apparatus/unit 200 outputs, is “ON”).

The control apparatus 100 sets the power source activation retention signal S1 at “OFF” in the case where the power source of the power source control object apparatus/unit 200 is to be set “OFF”. The power source control object apparatus/unit 200 starts power-off processing when the power source activation retention signal S1 becomes “OFF”, and sets the power source activation completion signal S3 at “OFF” when power-off is completed.

Note that the example shown in Figure shows a simple control, where an input signal from the power source control object apparatus/unit 200 is only one, however, this is only for illustration purpose. Communications by such a protocol is made in each of the power source control object apparatus/unit 200.

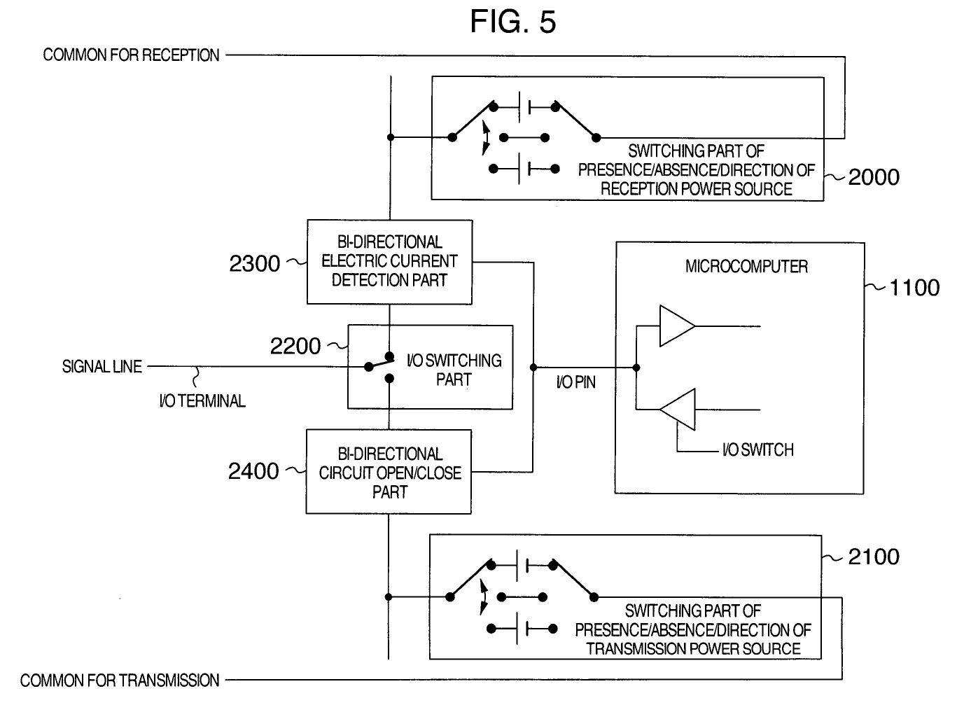

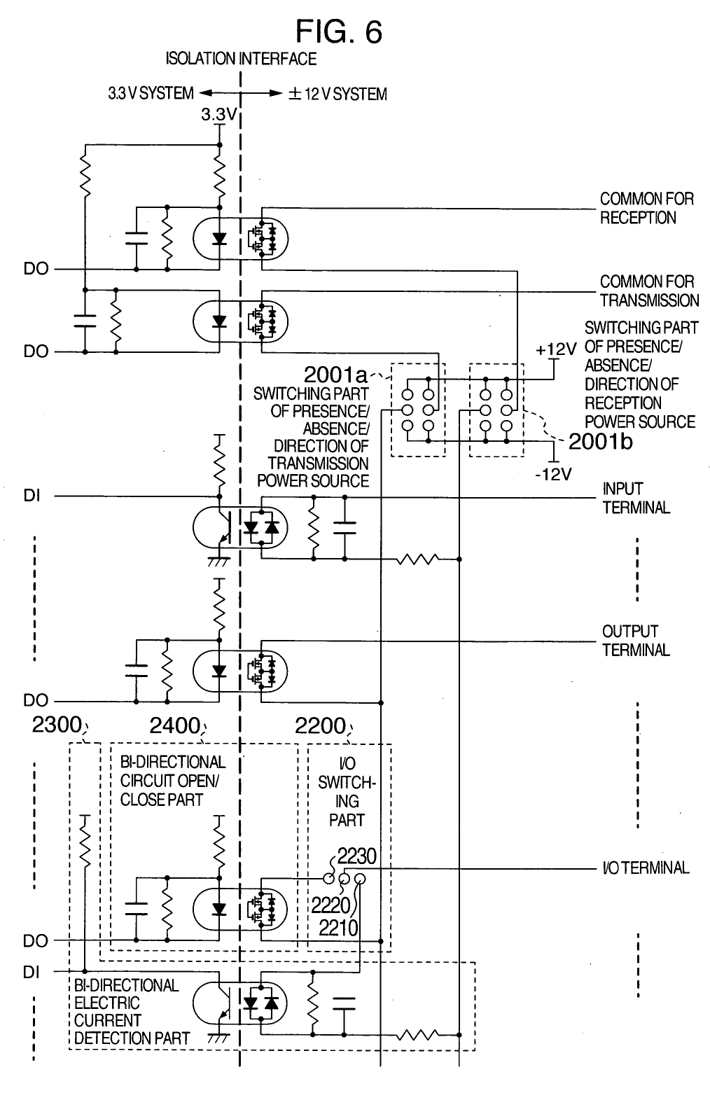

Subsequently, relationship between the contact signal received by the port 100 of the control apparatus 100 according to the present embodiment and the microcomputer 1100 of the control apparatus 100 is explained using FIG. 5 and FIG. 6.

FIG. 5 is a view for explaining relationship between the ISOIN 1110 or ISOOUT 1120 of the control apparatus 100 of the present embodiment and the microcomputer 1100.

As is illustrated, the ISOIN 1110 (or ISOOUT 1120) has a switching part 2000 of presence/absence/direction of reception power source, a switching part 2100 of presence/absence direction of transmission power source, an I/O switching part 2200, a bi-directional electric current detection part 2300 and a bi-directional circuit open/close part 2400.

The switching part 2000 of presence/absence/direction of reception power source is connected to a reception “common” via a common terminal (not shown in FIG. 5). And, the switching part 2000 of presence/absence/direction of reception power source selects a reception system. Specifically, the switching part 2000 of presence/absence/direction of reception power source selects whether power source is installed at a reception side (here, the control apparatus 100 side) or at outside of the reception side, such as a transmission side or external side, along with performing selection of a direction of electric current.

The switching part 2100 of presence/absence/direction of transmission power source is connected to a transmission “common” via a common terminal (not shown in FIG. 5). And, the switching part 2100 of presence/absence/direction of transmission power source selects a transmission system. Specifically, the switching part 2000 of presence/absence/direction of transmission power source selects whether power source is installed at a transmission side (here, the control apparatus 100 side) or at outside of a transmission side, such as a reception side or external side, along with performing selection of a direction of electric current.

In addition, an I/O switching part 2200, a bi-directional electric current detection part 2300 and a bi-directional circuit open/close part 2400 are installed at each of the I/O terminals of the port 110. In addition, in the explanation below, “I/O terminal” refers to a terminal other than the common terminal among the terminals of the port 110.

The bi-directional electric current detection part 2300 is for detecting electric current flowing bi-directionally on the contact signal side and insulates or isolates the contact signal from an internal circuit connected to the microcomputer 1100. The bi-directional circuit open/close part 2400 is for flowing electric current bi-directionally to the contact signal side and insulates or isolates the contact signal from an internal circuit connected to the microcomputer 1100.

The I/O switching part 2200 is connected to a signal line via the I/O terminal. And the I/O switching part 2200 switches connection of a signal line to the bi-directional electric current detection part 2300 or to the bi-directional circuit open/close part 2400. In the case where the I/O switching part 2200 connects the signal line to the bi-directional electric current detection part 2300, the I/O terminal connected to the signal line becomes an input terminal. In the case where the I/O switching part 2200 connects the signal line to the bi-directional circuit open/close part 2400, the I/O terminal connected to the signal line becomes an output terminal.

The bi-directional electric current detection part 2300 and the bi-directional circuit open/close part 2400, respectively, connect the I/O pin of the microcomputer 1100 and a signal line via the I/O switching part 2200. When viewed from the I/O pin of the microcomputer 1100, an input level signal is connected from the bi-directional electric current detection part 2300, while an output level signal is connected to the bi-directional circuit open/close part 2400. While two I/O pins may be provided, one for input and one for output, a single I/O pin can commonly be used by I/O switching, if the two circuits of the bi-directional electric current detection part 2300 and the bi-directional circuit open/close part 2400 are well designed suitably and appropriately.

FIG. 6 shows ISOIN 1110 or ISOOUT 1120 connecting to each terminal of a contact signal of a port which the control apparatus 100 of the present embodiment has and an internal circuit of the control apparatus excluding the I/O pin of the microcomputer 1100.

As is illustrated, in the present embodiment, setting of the switching part 2000 of presence/absence/direction of reception power source and the switching part 2100 of presence/absence/direction of transmission power source is executed by a jumper pin. In addition, in the example shown in Figure, the case where setting of the switching part 2000 of presence/absence/direction of reception power source and the switching part 2100 of presence/absence/direction of transmission power source is executed by a jumper pin is explained, however, it is only for illustration purpose. For example, setting of the switching part 2000 of presence/absence/direction of reception power source and the switching part 2100 of presence/absence/direction of transmission power source may also be executed by a lead line or a switch, instead of a jumper pin. In addition, setting of the switching part 2000 of presence/absence/direction of reception power source and the switching part 2100 of presence/absence/direction of transmission power source may also be executed by a signal from the microcomputer 1100.

Now, as is illustrated, the switching part 2000 of presence/absence/direction of reception power source and the switching part 2100 of presence/absence/direction of transmission power source are each installed with a terminal group 2001 arranged with three terminals (jumper pin terminals) in each of two rows, namely, right and left rows. Specifically, the switching part 2100 of presence/absence/direction of transmission power source is installed with the terminal group 2001a, and the switching part 2000 of presence/absence/direction of reception power source is installed with the terminal group 2001b.

In the case where the jumper pin terminals at “upper right” and “right center”, and the jumper pin terminals at “left center” and “lower left” are each connected, the power source is set to be present at own side, and electric current is set to flow from “common” to a signal line. In the case where the jumper pin terminals at “right center” and “lower right”, and the jumper pin terminals at “upper left” and “left center” are each connected, the power source is set to be present at own side and electric current is set to flow from a signal line to “common”. In the case where the jumper pin terminals at “left center” and “right center” are connected, power source is set not to be present at own side.

The I/O switching part 2200 connects an I/O terminal, which is connected to a signal line, to either one of the bi-directional electric current detection part 2300 and the bi-directional circuit open/close part 2400. Specifically, the I/O switching part 2200 has a jumper pin terminal 2220 which is connected to an I/O terminal, a jumper pin terminal 2210 which is connected to the bi-directional electric current detection part 2300, and a jumper pin terminal 2230 which is connected to the bi-directional circuit open/close part 2400.

In the example shown in Figure, in the case where the jumper pin terminal 2210 and the jumper pin terminal 2220 are connected, the I/O terminal is connected to the bi-directional electric current detection part 2300. In this case, the I/O terminal becomes an input terminal. On the other hand, in the case where the jumper pin terminal 2230 and the jumper pin terminal 2220 are connected, the I/O terminal is connected to the bi-directional circuit open/close part 2400. In this case, the I/O terminal becomes an output terminal.

Note that, in the example shown in Figure, the case where setting of the I/O switching part 2200 is carried out by a jumper pin is illustrated, however, there is no limitation thereto. Setting of the I/O switching part 2200 may also be carried out by a lead line, a switch or the microcomputer 1100, in the same way as the above-described switching part 2000 of presence/absence/direction of reception power source, and the switching part 2100 of presence/absence/direction of transmission power source.

Note also that the bi-directional electric current detection part 2300 uses a photocoupler comprising two LEDs reverse-parallel connected and is pulled up to Vcc (3.3 Volt) via a resister so as to convert the contact output of a photo transistor to the level signal. The bi-directional circuit open/close part 2400 is adapted to flow electric current bi-directionally using a photo relay.

The level signal connected to the I/O pin of the microcomputer, of the thus configured bi-directional electric current detection part 2300 and the bi-directional circuit open/close part 2400 is capable of commonly connecting to one I/O pin. As a result, one I/O terminal of a port can be used independently for input and output by setting.

Note that, in the control apparatus 100 of the present embodiment, all of the I/O terminals installed at the port 110 are not necessarily be composed of such a type that switching of I/O is possible. The number of the I/O terminals considered necessary for input and output may be set in advance as exclusive use for an input terminal and exclusive use for an output terminal. For example, at least one terminal among terminals of the port 110 may be set to compose such a type that switching of I/O is possible, and other terminals may be set as exclusive use for an input terminal and exclusive use for an output terminal.

In addition, in the present embodiment, as shown by the above-described FIG. 6, a photo-relay may be incorporated so that both a reception common and a transmission common are capable of being made open. When both a reception common and a transmission common are made open by adoption of such a configuration, all the I/O signals can be made open.

Next, modified examples of the present embodiment are explained.

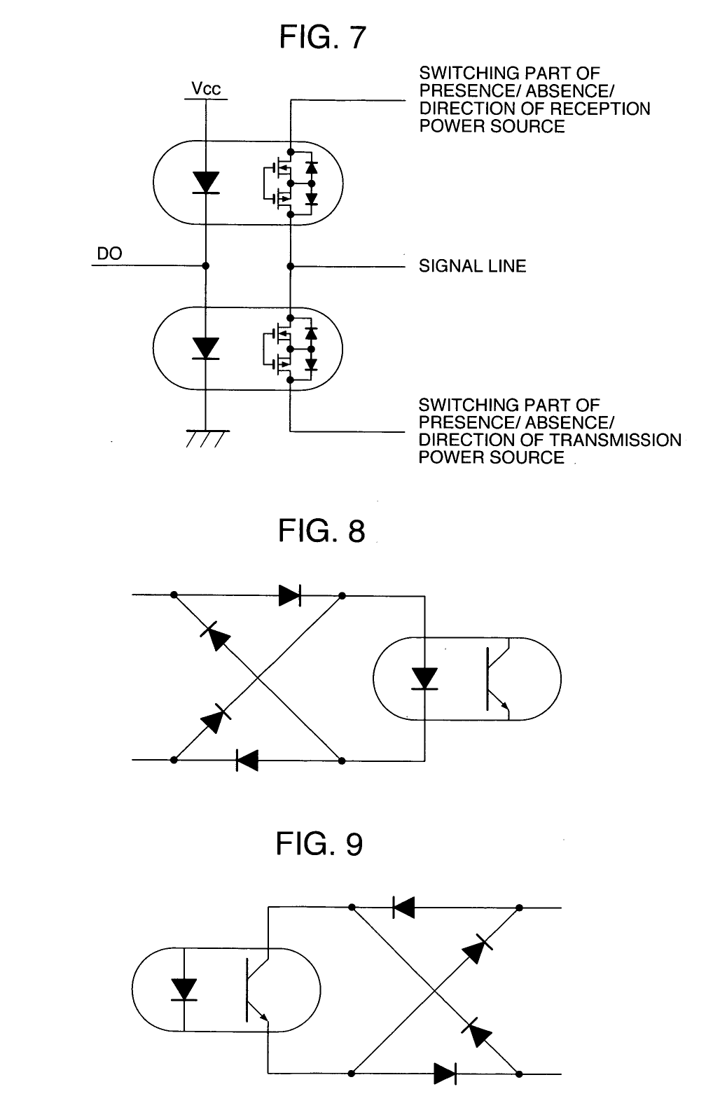

FIG. 7 shows a circuit configuration for setting the I/O switching part 2200 of the above-described control apparatus 100 from the I/O pin of the microcomputer 1100. Even by such a configuration, effect similar to the case by a jumper pin can be exerted. In addition, the switching part 2000 of presence/absence/direction of reception power source and the switching part 2100 of presence/absence/direction of transmission power source may also be set by the I/O pin of the microcomputer 1100.

FIG. 8 shows a circuit configuration in the case where the similar function is attained as a photocoupler connected in reverse-parallel, which the bi-directional electric current detector 2300 shown by FIG. 6 has, by a photocoupler having usual polarity. Even by making such a modification of configuration on the bi-directional electric current detector 2300, the function and effect similar to the above can be exerted.

In addition, FIG. 9 shows a circuit configuration in the case where the photo-relay of the bi-directional circuit open/close part 2400 shown by FIG. 6 is attained by a photocoupler having usual polarity. Even by making such a modification of configuration on the bi-directional circuit open/close part 2400, the function and effect similar to the above can be attained.

In addition, the present invention is by no means limited to the embodiments explained above, and various modifications are possible within the scope of the gist of the present invention. For example, in the present embodiment, such a modification is possible so that assign of a contact signal to a signal terminal (I/O terminal, common terminal) may be carried out by the cable 150 which is connected to the port 110 of the control apparatus 100.

1. A contact signal transmission and reception apparatus having a transmission and reception part for carrying out transmission and reception of a contact signal which is electrically insulated, comprising:
a plurality of signal terminals for carrying out transmission and reception of said contact signal are installed,
wherein said transmission and reception part has an I/O switching means for setting at least one signal terminal in said plurality of signal terminals at either one of an input terminal for inputting said contact signal and an output terminal for outputting said contact signal, selectively.

2. The contact signal transmission and reception apparatus according to claim 1, comprising:
a control part for controlling of transmission and reception of the setting signal carried out by said transmission and reception part,
wherein said I/O switching means carrying out selection of one of said input terminal and output terminal according to an electrical signal from said control part.

3. The contact signal transmission and reception apparatus according to claim 1, comprising a transmission and reception system setting means for setting whether or not power source for reception is set at own side, setting whether or not power source for transmission is set at own side, and setting a direction for flowing said contact signal.

4. The contact signal transmission and reception apparatus according to claim 3, wherein said I/O switching means selects one of said input terminal and said output terminal according to an electrical signal from said control part,
wherein said transmission and reception system setting means sets whether or not said power source for reception is set at own side, sets whether or not power source for transmission is set at own side, and sets a direction for flowing said contact signal, according to an electrical signal from said control part

5. A contact signal transmission and reception apparatus, having a transmission and reception part for carrying out transmission and reception of a contact signal which is electrically isolated, comprising:
ports with a plurality of signal terminals for carrying out transmission and reception of said contact signal;
said ports being installed in plurality by each communication target apparatus/unit for carrying out communication by said contact signal;
an I/O switching means for setting, for each port, at least one signal terminal among a plurality of signal terminals which said port has, to be either one of an input terminal for inputting said contact signal and an output terminal for outputting said contact signal, selectively; and
a transmission and reception system setting means for receiving, for each port, settings of whether or not power source for reception is set at own side, whether or not power source for transmission is set at own side, and a direction for flowing said contact signal.

6. The contact signal transmission and reception apparatus according to claim 5, comprising a control part installed with a microcomputer for controlling transmission and reception of said setting signal,
wherein assignment of a contact signal to a plurality of signal terminals which said ports have is changeable by a program of said microcomputer.

7. The contact signal transmission and reception apparatus according to claim 5, wherein said ports are installed with connectors for connecting connecting-cables for transmission and reception of a contact signal among said communication target apparatus/unit; and further comprising a conversion connector which converts shapes of the connectors installed at said ports to a shape of the connectors installed at said communication target apparatus/unit.

8. The contact signal transmission and reception apparatus according to claim 7, wherein said conversion connector changes the assignment of contact signals to a plurality of signal terminals of said ports.

9. The contact signal transmission and reception apparatus according to claim 5, wherein said ports are installed with connectors for connecting connecting-cables for transmission and reception of a contact signal among said communication target apparatus/unit,
wherein said connectors are connected with said connecting-cables and said connecting-cables change the assignment of contact signals to a plurality of signal terminals of said ports.
